(19) United States
(12) Patent Application Publication
(10) Pub. No.: US 2025/0042447 A1
(43) Pub. Date: Feb. 6, 2025

(54) CONTROLLER AND CONTROL METHOD

(71) Applicant: FUJI ELECTRIC CO., LTD., Kanagawa (JP)

(72) Inventors: Hidenori MATSUSHIMA, Kanagawa (JP); Jun KANDA, Hyogo (JP); Kenji FUJITA, Chiba (JP); Yoshio MORI, Mie (JP)

(21) Appl. No.: 18/779,645

(22) Filed: Jul. 22, 2024

(30) Foreign Application Priority Data
Aug. 1, 2023 (JP) 2023-125875

(51) Int. Cl. B61D 19/02

(52) U.S. Cl. CPC B61D 19/026; B61D 19/023

(57) ABSTRACT

A controller is configured to perform a process including operating or releasing an electrically driven hermetic retention device configured to retain airtightness between a door and an opening of a railway vehicle, according to whether or not there is a possibility of an opening operation of the door within a predetermined period.

### CROSS-REFERENCE TO RELATED APPLICATIONS

This application is based upon and claims priority to Japanese Patent Application No. 2023-125875, filed on Aug. 1, 2023, the entire contents of which are incorporated herein by reference.

### FIELD

Certain aspects of the embodiments discussed herein are related to controllers and control methods.

### BACKGROUND

Conventionally, there is a known hermetic retention device for maintaining airtightness between a door and an opening of a railway vehicle, as proposed in Japanese Laid-Open Patent Publication No. H9-11895, for example.

The hermetic retention device proposed in Japanese Laid-Open Patent Publication No. H9-11895 operates a cylinder device driven by compressed air, as an actuator.

It is conceivable to drive the hermetic retention device by an electric actuator.

### SUMMARY

Accordingly, one object of the present disclosure is to provide a technique capable of suitably controlling operation and release of an electrically driven hermetic retention device in the railway vehicle.

According to an aspect of one embodiment of the present disclosure, a controller is configured to perform a process including operating or releasing an electrically driven hermetic retention device configured to retain airtightness between a door and an opening of a railway vehicle, according to whether or not there is a possibility of an opening operation of the door within a predetermined period.

According to another aspect of one embodiment of the present disclosure, a control method includes operating or releasing, by a controller, an electrically driven hermetic retention device for retaining airtightness between a door and an opening of a railway vehicle according to whether or not there is a possibility of an opening operation of the door within a predetermined period.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a block diagram illustrating an example of a configuration related to an opening or closing operation of a door of a railway vehicle;

FIG. 2 is a schematic diagram illustrating an example of an arrangement and structure of a door and a door drive mechanism of a railway vehicle;

FIG. 3 is a schematic diagram illustrating the example of the arrangement and structure of the door and the door drive mechanism of the railway vehicle;

FIG. 4 is a schematic diagram illustrating the example of the arrangement and structure of the door and the door drive mechanism of the railway vehicle;

FIG. 5 is a schematic diagram illustrating the example of the arrangement and structure of the door and the door drive mechanism of the railway vehicle;

FIG. 6 is a schematic diagram illustrating the example of the arrangement and structure of the door and the door drive mechanism of the railway vehicle;

FIG. 7 is a diagram illustrating an example of a hermetic retention device;

FIG. 8 is a diagram illustrating a first example of an operation sequence of a configuration related to the opening or closing operation of the door of the railway vehicle;

FIG. 9 is a diagram illustrating a second example of the operation sequence of the configuration related to the opening or closing operation of the door of the railway vehicle;

FIG. 10 is a diagram illustrating a third example of the operation sequence of the configuration related to the opening or closing operation of the door of the railway vehicle; and

FIG. 11 is a diagram illustrating a fourth example of the operation sequence of the configuration related to the opening or closing operation of the door of the railway vehicle.

### DESCRIPTION OF EMBODIMENTS

Preferred embodiments of the present disclosure will be described with reference to the accompanying drawings. In the drawings, those parts that are the same are designated by the same reference numerals, and a repeated description of the same parts may be omitted.

### [Configuration Related to Door Opening or Closing Operation]

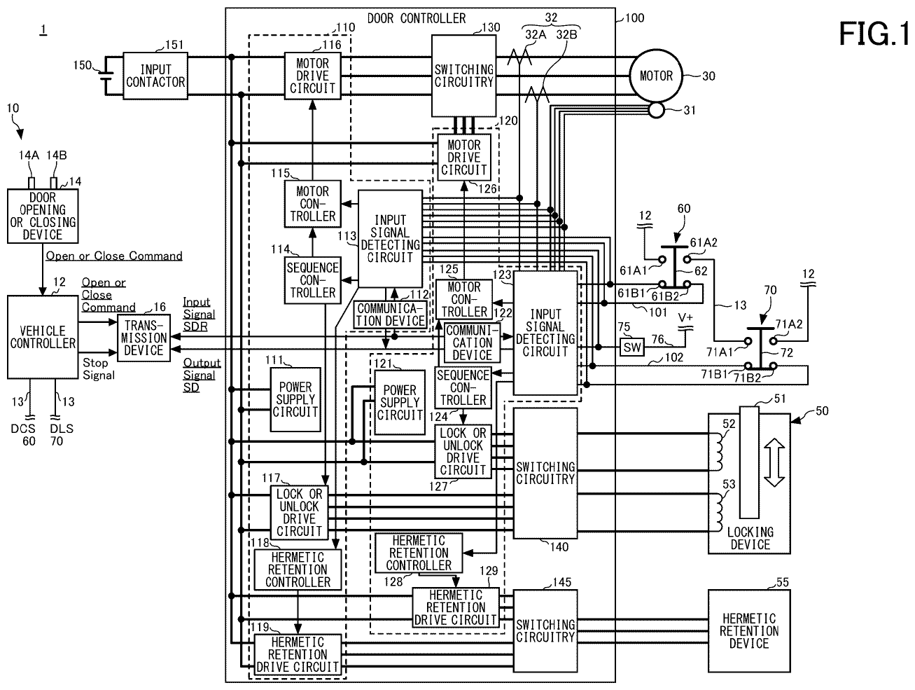

An example of a configuration related to an opening or closing operation of a door 80 of a railway vehicle 1 will be described, with reference to FIG. 1 through FIG. 7.

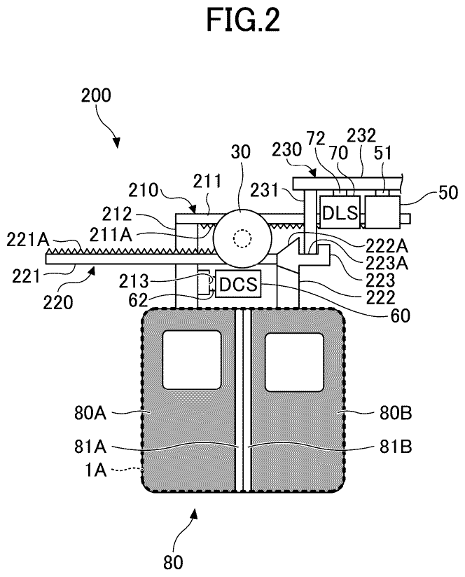

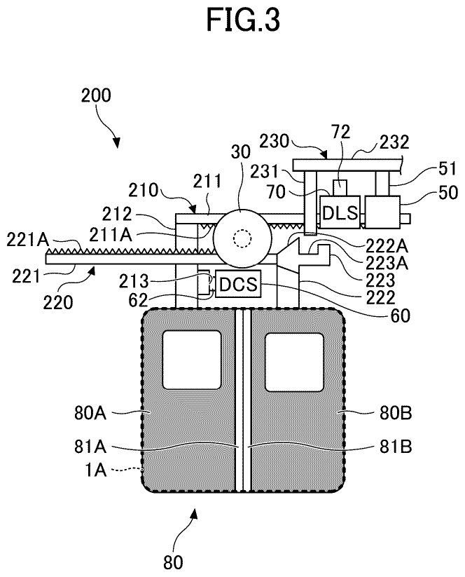

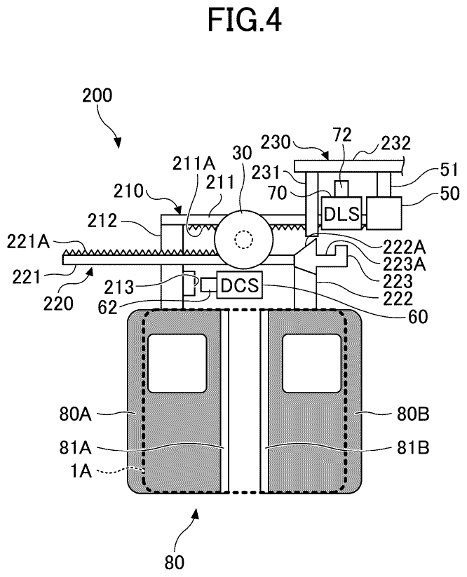

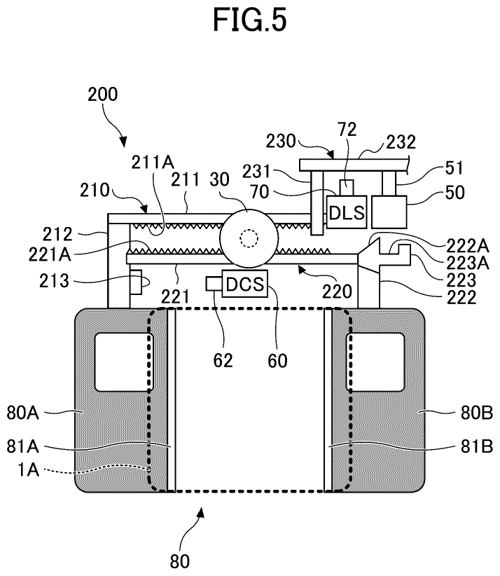

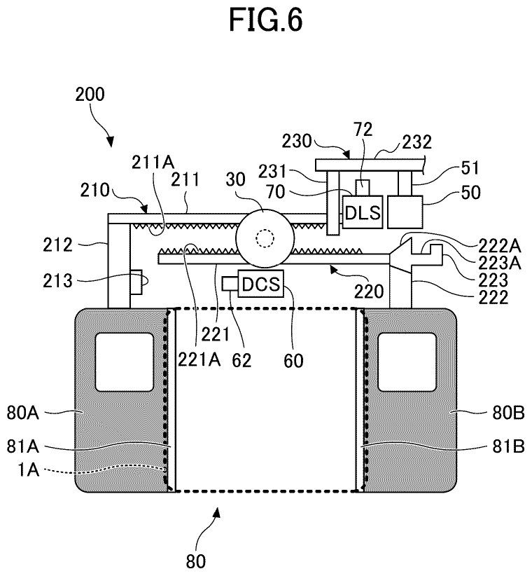

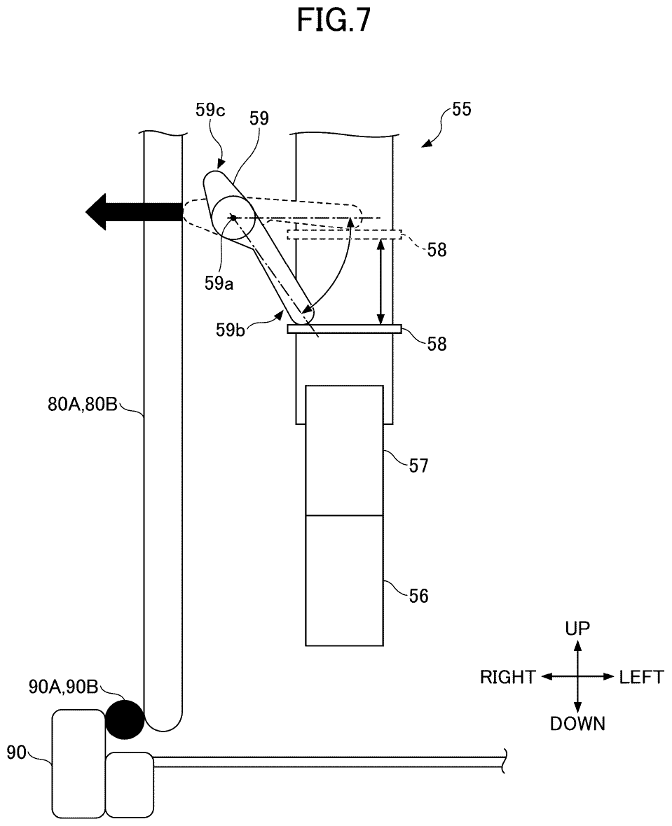

FIG. 1 is a block diagram illustrating an example of the configuration related to the opening or closing operation of the door 80 of the railway vehicle 1. FIG. 2 through FIG. 6 are schematic diagrams illustrating an example of an arrangement and structure of the door 80 and a door drive mechanism 200 of the railway vehicle 1. Specifically, FIG. 2 is a schematic diagram illustrating the door 80 and the door drive mechanism 200 in a fully closed and locked state of the door 80. FIG. 3 is a schematic diagram illustrating the door 80 and the door drive mechanism 200 in a fully closed and unlocked state. FIG. 4 is a schematic diagram illustrating the door 80 and the door drive mechanism 200 during an opening operation (immediately after starting of the opening operation) or during a closing operation (immediately before completion of the closing operation). FIG. 5 is a schematic diagram illustrating the door 80 and the door drive mechanism 200 during the opening operation (immediately before completion of the opening operation) or during the closing operation (immediately after starting of the closing operation). FIG. 6 is a schematic diagram illustrating the door 80 and the door drive mechanism 200 in a fully open state. FIG. 7 is a diagram illustrating an example of a hermetic retention device 55. Specifically, FIG. 7 is a front view of a body of the railway vehicle 1, the hermetic retention device 55, and door panels 80A and 80B as viewed from the front.

The railway vehicle 1 may be a single-car train composed of a single vehicle, or may be a multiple-car train composed of a plurality of vehicles connected in a train formation.

As illustrated in FIG. 1 through FIG. 6, the railway vehicle 1 includes a host device 10, a motor 30, an encoder 31, a current sensor 32, a locking device 50, the hermetic retention device 55, a door close switch (DCS) 60, a door lock switch (DLS) 70, a switch 75, and a door 80. In addition, the railway vehicle 1 includes a door controller 100, a power source 150, an input contactor 151, and a door drive mechanism 200.

The host device 10 includes a vehicle controller 12, a door opening or closing device 14, and a transmission device 16.

The vehicle controller 12 performs a control related to the operation of the railway vehicle 1. In a case where the railway vehicle 1 is a multiple-car train, for example, the vehicle controller 12 is provided in each of a driver's cabin of a first car and a conductor's cabin of a last car of the train formation. On the other hand, in a case where the railway vehicle is a single-car train, for example, the vehicle controller 12 is provided in each of the driver's cabin at a front end of the railway vehicle 1, and the conductor's cabin at a rear end of the railway vehicle 1.

Functions of the vehicle controller 12 can be implemented in arbitrary hardware, a combination of arbitrary hardware and software, or the like. The vehicle controller 12 is mainly composed of a computer including a central processing unit (CPU), a memory device, an auxiliary storage device, and an interface device for performing input and output with respect to an outside, for example. The memory device is a static random access memory (SRAM), for example. The auxiliary storage device is an electrically erasable programmable read only memory (EEPROM) or a flash memory, for example. The interface device includes a communication interface for connecting to a communication line inside the railway vehicle 1 or a communication line outside the railway vehicle 1, for example. Further, the interface device may include an external interface for connecting to an external recording medium. Thus, during a manufacturing process, an operator can install one or more programs and various data utilized for processes related to controlling the operation of the railway vehicle 1 from the external recording medium to the auxiliary storage device or the like of the vehicle controller 12. In addition, the one or more programs and various data utilized for the processes related to controlling the operation of the railway vehicle 1 may be downloaded from the outside of the railway vehicle 1 through the communication interface. The interface device may include a plurality of different types of interface devices according to the type of communication line to be connected to the interface device.

When the railway vehicle 1 is stopped at a station or the like, the vehicle controller 12 outputs a stop signal indicating that the railway vehicle 1 is stopped to the door controller 100. In addition, the vehicle controller 12 outputs an open command for instructing an opening operation of the door 80 or a close command for instructing a closing operation of the door 80, which is input from the door opening or closing device 14, to the door controller 100.

The vehicle controller 12 is connected to an interconnect 13 for transmitting an interlock signal. Both ends of the interconnect 13 are connected to the vehicle controller 12, and the DCS 60 and the DLS 70 are provided on the interconnect 13. In a case where at least one of the DCS 60 and the DLS 70 is in an off state, the interconnect 13 is in a non-conductive state, and in this case, the interlock signal input to the vehicle controller 12 has a low (L) level. On the other hand, in a case where both of the DCS 60 and the DLS 70 are in an on state, the interconnect 13 is in a conductive state, and in this case, the interlock signal input to the vehicle controller 12 has a high (H) level. The vehicle controller 12 determines that the railway vehicle 1 is in an operational state (that is, in a state able to run) when the interlock signal has the high level. For this reason, when the interlock signal makes a transition from the low level to the high level, the railway vehicle 1 becomes operational.

The door opening or closing device 14 is used by a crew member (for example, a conductor) of the railway vehicle 1 to perform an opening or closing operation of the door 80. The door opening or closing device 14 includes an opening switch 14A and a closing switch 14B. When the opening switch 14A is operated while the railway vehicle 1 is stopped, for example, the door opening or closing device 14 outputs an open command, which rises from the low level to the high level, to the vehicle controller 12. In addition, when the closing switch 14B is operated while the railway vehicle 1 is stopped, for example, the door opening or closing device 14 outputs a close command, which falls from the high level to the low level, to the vehicle controller 12.

The transmission device 16 relays signals between the door controller 100 of each of a plurality of doors 80 of the railway vehicle 1, and the vehicle controller 12.

Specifically, the transmission device 16 may receive various signals (input signals SDR) to be transmitted to the door controllers 100 from the vehicle controller 12, and transmit the signals to some or all of the door controllers 100. In addition, the transmission device 16 may receive various signals (output signals SD) to be transmitted to the vehicle controller 12 from the door controllers 100, and transmit the signals to the vehicle controller 12.

The motor 30 drives the door 80 to open and close. The motor 30 is a rotating machine driven by a three-phase alternating current (AC), for example. The motor 30 may be a linear motor driven by the three-phase alternating current. Moreover, the motor 30 may be a direct current motor driven by a direct current (DC).

The encoder 31 detects a rotational position and a displacement position of the motor 30. In a case where the motor 30 is a rotating machine, for example, the encoder 31 detects a rotational position (or a rotation angle) of a rotating shaft of the motor 30. For example, the encoder 31 detects a rotational position (or a rotation angle) during one rotation of the rotating shaft of the motor 30, and a revolution per unit time (or a rotation frequency) of the rotating shaft of the motor 30. The encoder 31 outputs a detection signal including information related to the rotational position of the rotating shaft of the motor 30, and the detection signal is input to the door controller 100. Thus, the door controller 100 can acquire position information of the door 80 in an opening or closing direction, based on the detection signal from the encoder 31. That is, the information included in the detection signal from the encoder 31 corresponds to the position information of the door 80.

The current sensor 32 detects a three-phase alternating current supplied from the door controller 100 to the motor 30. The current sensor 32 includes current sensors 32A and 32B that detect currents of two power lines among three power lines of a U-phase, a V-phase, and a W-phase connecting between the door controller 100 and the motor 30. For example, the current sensor 32A detects the current of the U-phase power line, and the current sensor 32B detects the current of the W-phase power line. The current sensor 32 may also include a current sensor that detects a current of the remaining one power line. For example, as illustrated in FIG. 1, the current sensor 32 may have a built-in configuration incorporated into the door controller 100, or may be provided outside the door controller 100. Detection signals from the current sensor 32 (the current sensors 32A and 32B) are input to a regular-use system controller 110 and a standby system controller 120 which will be described later.

The locking device 50 locks and unlocks the door 80. The locking device 50 includes a pin 51, and coils 52 and 53, for example, and may be formed by a bidirectional self-holding solenoid. The coils 52 and 53 are connected to the door controller 100.

When the coil 52 is energized by the door controller 100, the pin 51 protrudes from a housing of the locking device 50. As a result, a lock pin 230 which will be described later moves in an unlocking direction, and the door 80 is unlocked. In addition, because the locking device 50 is a self-holding locking device, the locking device 50 maintains a state where the pin 51 protrudes from the housing even after the energization of the coil 52 is released. Thus, the unlocked state of the door 80 can be maintained.

When the coil 53 is energized by the door controller 100, the pin 51 is pulled into the housing of the locking device 50. As a result, the lock pin 230 which will be described later moves in a locking direction, and the door 80 is locked. Moreover, because the locking device 50 is the self-holding locking device, the locking device 50 maintains a state where the pin 230 is pulled into the housing even after the energization of the coil 53 is released. Hence, the locked state of the door 80 can be maintained.

The hermetic retention device 55 maintains airtightness by preventing a flow of air between the door 80 and the opening of the vehicle body where the door 80 is provided, in the fully closed state of the door 80. Specifically, as illustrated in FIG. 7, the hermetic retention device 55 pushes the door panels 80A and 80B outward of the vehicle body toward seal members 90A and 90B provided along outer edge portions of structural members 90 at outer edge portions of the openings (as indicated by black arrows in FIG. 7). Further, instead of or in addition to the seal members 90A and 90B, seal members may be provided along the outer edge portions of the door panels 80A and 80B in side view. The hermetic retention device 55 is provided with respect to each of the door panels 80A and 80B. One or a plurality of hermetic retention devices 55 provided with respect to each of the door panels 80A and 80B. For example, four hermetic retention devices 55 may be provided with respect to the door panel 80A so as to push at four locations, namely, an upper front portion, an upper rear portion, a lower front portion, and a lower rear portion of the door panel 80A. Similarly, four hermetic retention devices 55 may be provided with respect to the door panel 80B. Further, for each of the door panels 80A and 80B, one of the four hermetic retention devices 55 may be omitted, and so as to maintain the airtightness by the three remaining hermetic retention devices 55.

For example, as illustrated in FIG. 7, the hermetic retention device 55 includes a servo motor 56, a motion conversion mechanism 57, a support 58, and a lever 59.

The servo motor 56 is a rotating machine driven by the three-phase alternating current supplied from the door controller 100. The servo motor 56 is disposed so as to rotate around an axis along a vertical direction (an up-down direction) of the railway vehicle 1. The servo motor 56 incorporates a deenergizing actuated electromagnetic brake, for example. Thus, the servo motor 56 can hold a rotational position corresponding to the released state or the operating state of the hermetic retention device 55 in a deenergized state (or an off state). For this reason, it is possible to reduce a power consumption of the hermetic retention device 55.

The motion conversion mechanism 57 converts a rotary motion around an axis along the vertical direction of the servo motor 56 into a linear motion in the vertical direction. Thus, the support 58 attached to a movable portion of the motion conversion mechanism 57 can move up and down according to the operation of the servo motor 56.

The support 58 supports one end portion (hereinafter also referred to as a “base end portion”) 59b of the lever 59 from below. The support 58 moves up and down according to the operation of the servo motor 56, and the base end portion 59b of the lever 59 moves up and down in response to the up and down movement of the support 58.

The lever 59 rotates about a rotating shaft 59a along a front-rear direction of the railway vehicle 1 in response to the up and down movement of the support 58 according to the operation of the servo motor 56. Specifically, in a case where the support 58 is located at a lowermost end position (indicated by a solid line in FIG. 7), a tip end portion 59c of the lever 59 is in a state separated from the door panel 80A or the door panel 80B. The state where the support 58 is located at the lowermost end position corresponds to a released state of the hermetic retention device 55. On the other hand, when the support 58 moves from the lowermost end position to an uppermost end position (indicated by a broken line in FIG. 7), the tip end portion 59c of the lever 59 approaches and makes contact with the door panel 80A or the door panel 80B while rotating clockwise about the rotating shaft 59a. The state where the support 58 is located at the uppermost end position corresponds to an operating state of the hermetic retention device 55. Thus, the lever 59 applies a pushing force on the door panel 80A or the door panel 80B from the inner side to the outer side, to improve an adhesion between the structural member 90 and the seal members 82A and 82B, and as a result, it is possible to improve the airtightness.

Detectors may be provided to detect the uppermost end position and the lowermost end position of the support 58. For example, the detectors may be a mechanical switch, such as a limit switch or the like. In addition, functions of the detectors may be provided in the door controller 100 as input signal detecting circuits 113 and 123 or the like, or as software. Specifically, the uppermost end position and the lowermost end position of the support 58 may be detected from information related to the operating state of the hermetic retention device 55 (for example, measurement information related to an operating speed, an operating distance, an operating time, or the like) or an electrical feature of the servo motor 56 (for example, measurement information related to a voltage, a current, or the like). For example, because a distance from the uppermost end position to the lowermost end position of the support 58 is constant, the uppermost end position and the lowermost end position of the support 58 can be detected by detecting a predetermined operating distance moved by the hermetic retention device 55 after the operation of the servo motor 56 is started.

Returning now to the description of FIG. 1 through FIG. 6, the DCS 60 performs a detection related to the open or closed state of the door 80 of the railway vehicle 1. Specifically, the DCS 60 detects a fully closed state where the door 80 of the railway vehicle 1 is fully closed. The DCS 60 may be a limit switch that is pressed by an action of the door 80 when the door 80 moves to the fully closed position, for example.

The DCS 60 includes fixed contacts 61A1 and 61A2, fixed contacts 61B1 and 61B2, and a movable contact 62.

The fixed contacts 61A1 and 61A2 are arranged in series with the interconnect 13 in a manner dividing the interconnect 13. Hereinafter, the fixed contacts 61A1 and 61A2 may also be referred to as “contacts A” of DCS 60 for the sake of convenience.

The fixed contacts 61B1 and 61B2 are arranged in series with an interconnect 101 in a manner dividing the interconnect 101 having both ends thereof connected to the door controller 100. Thus, the door controller 100 can recognize on and off states of the DCS 60 by a high-level signal and a low-level signal indicating an on (or conductive) state and an off (or non-conductive) state of the fixed contacts 61B1 and 61B2, respectively. Hereinafter, the fixed contacts 61B1 and 61B2 may also be referred to as “contacts B” of DCS 60 for the sake of convenience.

The movable contact 62 moves along an axial direction (the vertical direction in FIG. 1) to thereby turn one of the contacts A (fixed contacts 61A1 and 61A2) and the contacts B (fixed contacts 61B1 and 61B2) of the DCS 60 into the on (or conductive) state. In a state where no external force is applied, the DCS 60 is in a state where the movable contact 62 turns the contacts B into the on state, that is, the contacts B are in the on state and the contacts A are in the off state. On the other hand, when the movable contact 62 is pressed by the action of the door 80 as will be described later, the DCS 60 is in a state where the movable contact 62 turns the contacts A into the on state, that is, the contacts A are in the on state and the contacts B are in the off state. Further, when the movable contact 62 returns to the state not pressed by the action of the door 80, the DCS 60 returns to the state where the movable contact 62 turns the contacts B into the on state, that is, the contacts B are in the on state and the contacts A are in the off state.

For example, the door controller 100 can recognize the on and off states of the contacts B of the DCS 60, based on the signal input through the interconnect 101. In addition, the door controller 100 can recognize the on and off states of the contacts A of the DCS 60, by inverting the signal input through the interconnect 101, for example.

The DLS 70 detects whether or not the door 80 is locked. Specifically, the DLS 70 detects a locked state of the door 80. The DLS 70 may be a limit switch that is pressed by an action of a lock pin 230 when the lock pin 230 of the door 80 moves to a locked position, for example.

The DLS 70 includes fixed contacts 71A1 and 71A2, fixed contacts 71B1 and 71B2, and a movable contact 72.

The fixed contacts 71A1 and 71A2 are arranged in series with the interconnect 13, in a manner dividing the interconnect 13. Hereinafter, the fixed contacts 71A1 and 71A2 may also be referred to as “contacts A” of DLS 70 for the sake of convenience.

The fixed contacts 71B1 and 71B2 are arranged in series with an interconnect 102, in a manner dividing the interconnect 102 having both ends thereof connected to the door controller 100. Thus, the door controller 100 can recognize on and off states of the DLS 70 by a high-level signal and a low-level signal indicating an on (or conductive) state and an off (or non-conductive) state of the fixed contacts 71B1 and 71B2, respectively. Hereinafter, the fixed contacts 71B1 and 71B2 may also be referred to as “contacts B” of DLS 70 for the sake of convenience.

The movable contact 72 moves along an axial direction (the vertical direction in FIG. 1) to thereby turn one of the contacts A (fixed contacts 71A1 and 71A2) and the contacts B (fixed contacts 71B1 and 71B2) of the DLS 70 into the on (or conductive) state. In a state where no external force is applied, the DLS 70 is in a state where the movable contact 72 turns the contacts B into the on state, that is, the contacts B are in the on state and the contacts A are in the off state. On the other hand, when the movable contact 72 is pressed by the action of the lock pin 230, the DLS 70 is in a state where the movable contact 72 turns the contacts A into the on state, that is, the contacts A are in the on state and the contacts B are in the off state. Further, when the movable contact 72 returns to the state not pressed by the action of the lock pin 230, the DLS 70 returns to the state where the movable contact 72 turns the contacts B into the on state, that is, the contacts B are in the on state and the contacts A are in the off state.

For example, the door controller 100 can recognize the on and off states of the contacts B of the DLS 70, based on the signal input through the interconnect 102. In addition, the door controller 100 can recognize the on and off states of the contacts A of the DLS 70, by inverting the signal input through the interconnect 102, for example.

When the door 80 is fully closed and locked and the contacts A of the DCS 60 and the contacts A of the DLS 70 are both turned on, the interconnect 13 assumes a conductive state and the interlock signal assumes a high level.

The switch 75 is used to permit opening of the door 80 on the left or right side of the railway vehicle 1. The switch 75 is provided with respect to each of the door 80 on the left side and the door 80 on the right side of the railway vehicle 1. For example, the switches 75 are provided in at least one of the driver's cab and the conductor's cab of the railway vehicle 1, and are turned on and off in response to an operation performed by the driver or the conductor. For example, the driver or the conductor turns on the switch 75 for the left door 80 immediately before stopping at a stop station where a platform for getting on or off the railway vehicle 1 is adjacent to the left side of the railway vehicle 1, and turns on the switch 75 for the right door 80 immediately before stopping at a stop station where a platform for getting on or off the railway vehicle 1 is adjacent to the right side of the railway vehicle 1.

Specifically, the switch 75 switches the signal line 76 between a connected state and a disconnected state in response to the operation performed by the driver or the conductor. The signal line 76 is provided for each of the left door 80 and the right door 80 of the railway vehicle 1. The signal line 76 for the left door 80 is connected to the door controller 100 which controls the left door 80 as a control target, from a predetermined DC power source through the switch 75 for the left door 80. Thus, in a case where the switch 75 for the left door 80 is in the off state, a low-level signal (or an off signal) is input to the door controller 100 which controls the left door 80 as the control target. On the other hand, in a case where the switch 75 for the left door 80 is in the on state, a signal of a high-level signal (or an on signal) is input to the door controller 100 which controls the left door 80 as the control target. Similarly, in a case where the switch 75 for the right door 80 is in the off state, a low-level signal (or an off signal) is input to the door controller 100 which controls the right door 80 as the control target. On the other hand, in a case where the switch 75 for the right door 80 is in the on state, a high-level signal (or an on signal) is input to the door controller 100 which controls the right door 80 as the control target. For this reason, the signal line 76 can transmit to the door controller 100 a signal (hereinafter also referred to as a “platform-side signal”) corresponding to the on or off state of the switch 75, that is, a signal indicating whether or not the door 80 that is the control target of the door controller 100 is provided on the side adjacent to the platform of the next stop station.

The door 80 is provided at the opening (hereinafter also referred to as a “door opening”) on each of the right and left sides of the vehicle body of the railway vehicle 1. The door 80 is a double sliding door including the door panels 80A and 80B, for example.

The door panels 80A and 80B perform the opening or closing operation of the door 80 (at the door opening of the vehicle body) by the power of the motor 30 through the door drive mechanism 200. Specifically, the door panels 80A and 80B can open and close the door opening of the vehicle body by performing symmetrical operations in the front-rear direction with respect to a center of the door opening of the vehicle body along the front-rear direction.

In the fully closed state of the door 80, door tip rubbers 81A and 81B are provided at portions of the door panels 80A and 80B that make contact with each other, respectively. The door tip rubbers 81A and 81B are provided in a range from an upper end to a lower end at a contacting portions of the door panels 80A and 80B, respectively.

The door 80 may be a single sliding door. In this case, the door 80 includes a single door panel.

The door controller 100 performs a control related to the opening or closing operation of the door 80. The door controller 100 is provided with respect to each of the plurality of doors 80 provided in the railway vehicle 1.

Functions of the door controller 100 can be implemented in arbitrary hardware, a combination of arbitrary hardware and software, or the like. The door controller 100 is mainly composed of a computer including a CPU, a memory device, an auxiliary storage device, and an interface device for performing input and output with respect to an outside, for example. The memory device is a SRAM, for example. The auxiliary storage device is an EEPROM or a flash memory, for example. The interface device includes a communication interface for connecting to a communication line inside the railway vehicle 1 or a communication line outside the railway vehicle 1, for example. Further, the interface device may include an external interface for connecting to an external recording medium. Thus, during a manufacturing process, an operator can install one or more programs and various data utilized for processes related to controlling the door 80 from the external recording medium to the auxiliary storage device or the like of the door controller 100. In addition, the one or more programs and various data utilized for the processes related to controlling the door 80 may be downloaded from the host device 10 through the communication interface. The interface device may include a plurality of different types of interface devices according to the type of communication line to be connected to the interface device.

The door controller 100 includes the regular-use system controller 110, the standby system controller 120, the switching circuitry 130, a switching circuitry 140, and a switching circuitry 145.

The regular-use system controller 110 performs a control related to the opening or closing operation of the door 80. The regular-use system controller 110 includes a power supply circuit 111, a communication device 112, an input signal detecting circuit 113, a sequence controller 114, a motor controller 115, a motor drive circuit 116, a lock or unlock drive circuit 117, a hermetic retention controller 118, and a hermetic retention drive circuit 119.

The power supply circuit 111 functions as a drive power source for various devices of the regular-use system controller 110. The power supply circuit 111 generates a power of a relatively low voltage (for example, 5 V or lower) for driving the devices of the regular-use system controller 110, using a power of a relatively high voltage (for example, 100 V) supplied to the door controller 100 from the power source 150.

The communication device 112 performs bidirectional communications with the transmission device 16 outside the door controller 100.

The input signal detecting circuit 113 detects various signals input from the outside of the door controller 100.

In addition, the input signal detecting circuit 113 may perform various processes based on the detected signals.

For example, when the input signal detecting circuit 113 detects a predetermined signal from among the input signals, the input signal detecting circuit 113 transmits the predetermined signal to the sequence controller 114, the motor controller 115, and the hermetic retention controller 118. That is, the input signal detecting circuit 113 extracts (or selects) a signal required for the control of the sequence controller 114 or the motor controller 115 from a plurality of types of input signals, and transmits the extracted (or selected) signal to the sequence controller 114 or the motor controller 115. Thus, the sequence controller 114 and the motor controller 115 can suitably perform a sequence control and a drive control of the motor 30 which will be described later, respectively, based on the signal input from the input signal detecting circuit 113.

Moreover, the input signal detecting circuit 113 may perform a diagnosis related to an abnormality of at least one configuration related to the opening or closing operation of the door 80, such as the door 80, the motor 30, the locking device 50, the hermetic retention device 55, or the like, based on the input signals. The diagnosis related to abnormality includes a diagnosis of a presence or an absence of the abnormality. Further, the diagnosis related to the abnormality may include a diagnosis of a degree of abnormality (or an extent of abnormality).

For example, the input signal detecting circuit 113 performs a diagnosis related to an abnormality of the hermetic retention device 55, based on a signal indicating information related to the operating state of the hermetic retention device 55 and included in the input signals. The information related to the operating state of the hermetic retention device 55 includes measurement information related to the operating speed, the operating distance, the operating time, or the like, and information related to the electrical feature, such as the current, the voltage, or the like of the servo motor 56. Specifically, the input signal detecting circuit 113 may diagnose the presence or absence of the abnormality or the degree of abnormality of the hermetic retention device 55, by comparing the information related to the operating state of the hermetic retention device 55 with reference information corresponding to a normal state or an abnormal state of the hermetic retention device 55. For example, the input signal detecting circuit 113 diagnoses the abnormality or the degree of abnormality regarding a grease depletion at the motion conversion mechanism 57 or the rotating shaft 59a, when the operating speed of the hermetic retention device 55 is lower than the reference information or the operating time of the hermetic retention device 55 is longer than the reference information. In addition, in a case where the operating distance of the hermetic retention device 55 does not reach the reference information, the input signal detecting circuit 113 may diagnose a presence of a foreign object pinched between the structural member 90 and the seal members 90A and 90B, or the presence or absence of the abnormality or the degree of abnormality regarding the seal members 90A and 90B. Moreover, the input signal detecting circuit 113 may diagnose the presence or absence of the abnormality of the hermetic retention device 55 based on the information related to the operating state of the hermetic retention device 55, using a trained model (classifier) generated by supervised learning.

Similarly, the input signal detecting circuit 113 may perform a diagnosis related to an abnormality of the motor 30, the door 80, or the locking device 50, based on a signal indicating information related to the operating state of the motor 30, the door 80, or the locking device 50 included in the input signals.

The input signal detecting circuit 113 may perform a diagnosis related to an indication (or sign) of abnormality of at least one of the door 80, the motor 30, the locking device 50, and the hermetic retention device 55, based on the input signals. The diagnosis related to the indication of abnormality (hereinafter also referred to as an “abnormality indication”) includes a diagnosis of the presence or absence of the abnormality indication, for example. The diagnosis of the abnormality indication may include a diagnosis of the degree of the abnormality indication.

For example, the input signal detecting circuit 113 performs a diagnosis related to the abnormality indication of the hermetic retention device 55, based on a history of a signal (or data) indicating information related to the operating state of the hermetic retention device 55 and included in the input signals. Specifically, the input signal detecting circuit 113 may perform the diagnosis related to the abnormality indication of the hermetic retention device 55, based on a tendency of a change in the information related to the operating state of the hermetic retention device 55.

Similarly, the input signal detecting circuit 113 may perform a diagnosis related to the abnormality indication of the motor 30, the door 80, or the locking device 50, based on a history of a signal indicating information related to the operating state of the motor 30, the door 80, or the locking device 50 and included in the input signals.

In addition, the input signal detecting circuit 113 may diagnose the presence or absence of the abnormality or the degree of abnormality of at least one of the door 80, the motor 30, the locking device 50, and the hermetic retention device 55, from a consistency of the plurality of input signals. For example, the input signal detecting circuit 113 may diagnose the presence or absence of abnormality and the degree of abnormality of the hermetic retention device 55, based on a consistency between the information on the contacts of the DCS 60 and the DLS 70 and the hermetic retention device 55. When the hermetic retention device 55 is in the operating state in a situation where the signal indicating the open state of the door 80 is output from the DCS 60 and the DLS 70, the input signal detecting circuit 113 can diagnose the presence of the abnormality in the hermetic retention device 55 or a relatively high degree of abnormality of the hermetic retention device 55.

The diagnosis of the abnormality or the abnormality indication of the configuration related to the opening or closing operation of the door 80, such as the door 80, the motor 30, the locking device 50, the hermetic retention device 55, or the like may be performed by the vehicle controller 12 or an information processing apparatus (for example, a server apparatus) outside the railway vehicle 1. In this case, a diagnosis result of the abnormality regarding the configuration related to the opening or closing operation of a large number of doors 80 or the data utilized for the diagnosis related to the abnormality, corresponding to big data, may be utilizable. In this case, the vehicle controller 12 or the like may diagnose the presence or absence of the abnormality indication of the configuration related to the opening or closing operation of the target door 80, by applying a machine learning (or an unsupervised learning), such as clustering or the like, based on information of the diagnosis result of the abnormality regarding the configuration related to the opening or closing operation of a large number of doors 80 or data utilized for the diagnosis.

The sequence controller 114 performs a sequence control related to the opening or closing operation of the door 80, based on the signals input from the input signal detecting circuit 113. Specifically, the sequence controller 114 performs the sequence control related to the opening or closing operation of the door 80 in response to the stop signal, the open command, the close command, or the like from the vehicle controller 12. In addition, the sequence controller 114 may perform the sequence control related to the opening or closing operation of the door 80, while recognizing the open or closed state of the door 80, the position of the door 80 in the opening or closing direction, whether or not the door 80 is locked, or the like, using the signals from the encoder 31, the DCS 60, the DLS 70, or the like.

The motor controller 115 controls the driving of the motor 30 in response to a control command related to the opening or closing operation of the door 80 from the sequence controller 114, so as to perform the opening or closing operation of the door 80 corresponding to the control command. The motor controller 115 generates a pulse width modulation (PWM) signal for driving the motor 30, based on a speed command and a thrust command of the motor 30 input from the sequence controller 114, for example, and outputs the PWM signal to the motor drive circuit 116. Specifically, the motor controller 115 may generate a PWM signal that matches the speed command and the thrust command, using the detection signals of the encoder 31, the current sensor 32, or the like which are input from the input signal detecting circuit 113, while recognizing the current of the motor 30, the rotational position of the rotating shaft, or the like.

The motor drive circuit 116 generates and outputs a three-phase alternating current for driving the motor 30, using a direct current input from the power source 150. The motor drive circuit 116 includes an inverter circuit that converts the direct current into the three-phase alternating current having a predetermined voltage and a predetermined frequency, for example. The motor drive circuit 116 has two DC power lines on the input side thereof connected to the power source 150 through the input contactor 151, and three power lines on the output side thereof connected to the motor 30 through the switching circuitry 130.

The lock or unlock drive circuit 117 energizes the coils 52 and 53 of the locking device 50 in response to a locking command or an unlocking command input from the sequence controller 114, and drives the locking device 50 (or the pin 51) in the locking direction or the unlocking direction of the door 80. The lock or unlock drive circuit 117 has a positive line and a negative line on the input side thereof which are DC power lines connected to the power source 150 through the input contactor 151. In the lock or unlock drive circuit 117, one of two pairs of DC power lines, that is, a positive line and a negative line on the output side of the lock or unlock drive circuit 117, is connected to the coil 52 through the switching circuitry 140, and the other of the two pairs of DC power lines is connected to the coil 53 through the switching circuitry 140. For example, the lock or unlock drive circuit 117 includes a semiconductor switch capable of causing a state between the DC power lines on the input side and the two pairs of DC power lines on the output side to switch between a conductive state and a non-conductive state, and switches the semiconductor switch on and off. Specifically, when the unlocking command is input from the sequence controller 114, the lock or unlock drive circuit 117 may cause the state between the DC power lines on the input side and one of the pair of DC power lines on the output side to switch to the conductive state, and cause the coil 52 of the locking device 50 to be energized through the switching circuitry 140. On the other hand, when the lock or unlock drive circuit 117 receives the locking command from the sequence controller 114, the lock or unlock drive circuit 117 may cause the state between the DC power lines on the input side and the other of the pair of DC power lines on the output side to switch to the conductive state, and cause the coil 53 of the locking device 50 to be energized through the switching circuitry 140.

The hermetic retention controller 118 outputs a control command to a hermetic retention drive circuit 129, based on the signal input from the input signal detecting circuit 113, and controls the driving of the hermetic retention device 55. Specifically, the hermetic retention controller 118 determines whether or not there is a possibility of the opening operation of the door 80 in a near future (that is, within a predetermined period), for example, based on the signal input from the input signal detecting circuit 113, and controls the driving of the hermetic retention device 55. More particularly, in a case where the hermetic retention controller 118 determines that there is a possibility of the opening operation of the door 80 in the near future, based on the signal input from the input signal detecting circuit 113, the hermetic retention controller 118 may make a transition from the operating state to the released state as a preliminary stage of the opening operation of the door 80. Further, in a case where the hermetic retention controller 118 determines that there is no possibility of the opening operation of the door 80 in the near future, based on the signal input from the input signal detecting circuit 113, the hermetic retention controller 118 may make a transition from the released state to the operating state.

The hermetic retention drive circuit 119 generates and outputs a three-phase AC voltage for driving the servo motor 56 from a DC voltage input from the power source 150, in response to a control command from the hermetic retention controller 118. The hermetic retention drive circuit 119 includes an inverter circuit that converts the DC voltage into the three-phase AC voltage having a predetermined voltage and a predetermined frequency, for example. The hermetic retention drive circuit 119 has two DC power lines on the input side thereof connected to the power source 150 through the input contactor 151, and three power lines on the output side thereof connected to the motor 30 through the switching circuitry 145.

The standby system controller 120 is configured to be able to perform a control related to the opening or closing operation of the door 80, and provides a backup function for the regular-use system controller 110. Accordingly, because the door controller 100 is provided with the standby system controller 120 in addition to the regular-use system controller 110, it is possible to provide a redundancy of the control system related to the opening or closing operation of the door 80. Specifically, in a case where an abnormality is generated in the regular-use system controller 110, the standby system controller 120 performs the control related to the opening or closing operation of the door 80 in place of the regular-use system controller 110.

The standby system controller 120 includes the same constituent elements as the regular-use system controller 110. Specifically, the standby system controller 120 includes a power supply circuit 121, a communication device 122, an input signal detecting circuit 123, a sequence controller 124, a motor controller 125, a motor drive circuit 126, a lock or unlock drive circuit 127, a hermetic retention controller 128, and the hermetic retention drive circuit 129.

The power supply circuit 121 has the same hardware configuration and functions as the power supply circuit 111 of the regular-use system controller 110. The communication device 122 has the same hardware configuration and functions as the communication device 112 of the regular-use system controller 110. The input signal detecting circuit 123 has the same hardware configuration and functions as the input signal detecting circuit 113 of the regular-use system controller 110. The sequence controller 124 has the same hardware configuration and functions as the sequence controller 114 of the regular-use system controller 110. The motor controller 125 has the same hardware configuration and functions as the motor controller 115 of the regular-use system controller 110. The motor drive circuit 126 has the same hardware configuration and functions as the motor drive circuit 116 of the regular-use system controller 110. The lock or unlock drive circuit 127 has the same hardware configuration and functions as the lock or unlock drive circuit 117 of the regular-use system controller 110. The hermetic retention controller 128 has the same hardware configuration and functions as the hermetic retention controller 118 of the regular-use system controller 110. The hermetic retention drive circuit 129 has the same hardware configuration and functions as the hermetic retention drive circuit 119 of the regular-use system controller 110. For this reason, a detailed description of these same constituent elements will be omitted.

The switching circuitry 130 switches between a state where the motor drive circuit 116 and the motor 30 are electrically connected, and a state where the motor drive circuit 126 and the motor 30 are electrically connected. Specifically, the switching circuitry 130 has an input side thereof connected to three-phase AC output power lines of the motor drive circuit 116 and the motor drive circuit 126, and an output side thereof connected to a three-phase AC input power line extending from the motor 30. The switching circuitry 130 switches between a state where the output power line of the motor drive circuit 116 and the input power line of the motor 30 are in the on (or conductive) state, and a state where the output power line of the motor drive circuit 126 and the input power line of the motor 30 are in the on (or conductive) state.

In the case where the regular-use system controller 110 performs the control related to the opening or closing operation of the door 80, the switching circuitry 130 maintains the state where the motor drive circuit 116 and the motor 30 are electrically connected. On the other hand, in the case where an abnormality is generated in the regular-use system controller 110 and the standby system controller 120 makes a transition to the state where the control related to the opening or closing operation of the door 80 is performed thereby, the switching circuitry 130 switches to the state where the motor drive circuit 126 and the motor 30 are electrically connected.

The switching circuitry 140 switches between a state where the lock or unlock drive circuit 117 and the locking device 50 (coils 52 and 53) are connected, and a state where the lock or unlock drive circuit 127 and the locking device 50 (coils 52 and 53) are connected. Specifically, the switching circuitry 140 has two pairs of output power lines of the lock or unlock drive circuit 117 and the lock or unlock drive circuit 127 connected to the input side thereof, and two pairs of input power lines extending from the locking device 50 (coils 52 and 53) connected to the output side thereof. The switching circuitry 140 switches between a state where the two pairs of output power lines of the lock or unlock drive circuit 117 are connected to the two pairs of input power lines of the locking device 50, and a state where the two pairs of output power lines of the lock or unlock drive circuit 127 are connected to the two pairs of input power lines of the locking device 50.

In a case where the regular-use system controller 110 performs the control related to the opening or closing operation of the door 80, the switching circuitry 140 maintains the state where the lock and unlock drive circuit 117 and the locking device 50 (coils 52 and 53) are electrically connected. On the other hand, in the case where an abnormality is generated in the regular-use system controller 110 and a transition is made to the state where the standby system controller 120 performs the control related to the opening or closing operation of the door 80, the switching circuitry 140 switches to the state where the lock and unlock drive circuit 127 and the locking device 50 (coils 52 and 53) are electrically connected.

The switching circuitry 145 switches between a state where the hermetic retention drive circuit 119 and the hermetic retention device 55 are electrically connected, and a state where the hermetic retention drive circuit 129 and the hermetic retention device 55 are electrically connected. Specifically, the switching circuitry 145 has an input side thereof connected to the three-phase AC output power lines of the hermetic retention drive circuit 119 and the hermetic retention drive circuit 129, and an output side thereof connected to the three-phase AC input power line extending from the hermetic retention device 55. The switching circuitry 145 switches between a state where the output power line of the hermetic retention drive circuit 119 and the input power line of the hermetic retention device 55 are in the on (or conductive) state, and a state where the output power line of the hermetic retention drive circuit 129 and the input power line of the hermetic retention device 55 are in the on (or conductive) state.

In the case where the control related to the opening or closing operation of the door 80 is performed by the regular-use system controller 110, the switching circuitry 145 maintains the state where the hermetic retention drive circuit 119 and the hermetic retention device 55 are electrically connected. On the other hand, in the case where an abnormality is generated in the regular-use system controller 110 and a transition is made to the state where the standby system controller 120 performs the control related to the opening or closing operation of the door 80, the switching circuitry 145 switches to a state where the hermetic retention drive circuit 129 and the hermetic retention device 55 are electrically connected.

The power source for driving a main body of the servo motor 56 of the hermetic retention device 55 and the power source for releasing the deenergizing actuated electromagnetic brake incorporated into the servo motor 56 may be the same or different. In the latter case, only the power source for releasing the brake may be made redundant, for example, so as to reduce a current capacity of the switching circuitry 145, thereby simultaneously achieving improved reliability and size and weight reduction of the device.

The power source 150 supplies a predetermined DC voltage (for example, 100 V) to various devices of the railway vehicle 1, including the motor 30, the locking device 50, the hermetic retention device 55, and the door controller 100. The power source 150 includes a battery and an auxiliary power supply device, for example. The battery supplies a DC power to the various devices of the railway vehicle 1 in a state where the pantograph of the railway vehicle 1 does not make contact with an overhead wire or line. The auxiliary power supply device generates a direct current based on the electric power supplied from the overhead wire or line through the pantograph in a state where the pantograph of the railway vehicle 1 makes contact with the overhead wire or line, and supplies the direct current to the various devices of the railway vehicle 1.

The input contactor 151 is provided in a power circuit between the power source 150 and the various devices of the railway vehicle 1 including the door controller 100, and switches the power supply to the various devices on or off by opening or closing the power circuit. The input contactor 151 is closed in response to a predetermined operation corresponding to a power on operation performed in the driver's cabin of the railway vehicle 1, for example. In this case, the supply of power to the various devices of the railway vehicle 1 including the door controller 100 is started, and the railway vehicle 1 is started. In addition, the input contactor 151 is opened in response to a predetermined operation corresponding to a power off operation performed in the driver's cabin of the railway vehicle 1, for example. In this case, the supply of power to the various devices of the railway vehicle 1 including the door controller 100 is stopped (or interrupted), and the railway vehicle 1 is stopped.

The door drive mechanism 200 transmits the power of the motor 30 to the door 80, to perform the opening or closing operation of the door 80 (the door panels 80A and 80B). The door drive mechanism 200 achieves the locked state or the unlocked state of the door 80, according to the operation of the locking device 50 (or the pin 51).

The door drive mechanism 200 includes racks 210 and 220, and a lock pin 230.

The rack 210 is attached to an upper end portion of the door panel 80A. The rack 210 includes a rack portion 211 and a connecting portion 212.

The rack portion 211 is a member extending in the front-rear direction of the railway vehicle 1. A rack gear 211A is provided on a lower surface of the rack portion 211. The rack portion 211 is disposed slightly above the rotating shaft of the motor 30 that is disposed so that the rotating shaft extends along a width direction (or a left-right direction) of the railway vehicle 1 above the door opening of the railway vehicle 1 (or the vehicle body). Thus, a pinion gear disposed coaxially with the rotating shaft of the motor 30 can be engaged with the rack gear 211A on the lower surface of the rack portion 211. For this reason, the rack portion 211 can be moved in the front-rear direction of the railway vehicle 1, according to the rotation of the motor 30.

The connecting portion 212 connects the door panel 80A and the rack portion 211. The connecting portion 212 is provided so as to extend upward from the upper end portion of the door panel 80A, and the rack portion 211 is connected to an upper end of the connecting portion 212. Thus, the door panel 80A moves in the front-rear direction of the railway vehicle 1, coordinated with a movement of the rack portion 211 according to the rotation of the motor 30, thereby achieving the opening or closing operation of the door 80. In this state, the door panel 80A is guided by a slide rail (hereinafter also referred to as a “door rail”) to move in the front-rear direction.

The connecting portion 212 is provided with a DCS contact 213.

As illustrated in FIG. 2 and FIG. 3, when the door panels 80A and 80B assume the fully closed state, the DCS contact 213 makes contact with the movable contact 62 of the DCS 60, and presses against the movable contact 62. As a result, the movable contact 62 is pressed inward, and the DCS 60 is turned on. On the other hand, as illustrated in FIG. 4 through FIG. 6, when the door panel 80A assumes a state other than the fully closed state, the DCS contact 213 makes a transition to a state where the DCS contact 213 does not make contact with the movable contact 62 of the DCS 60, and the DCS 60 is turned off.

The rack 220 is attached to an upper end portion of the door panel 80B. The rack 220 includes a rack portion 221, a connecting portion 212, and a lock pin contact 223.

The rack portion 221 is a member extending in the front-rear direction of the railway vehicle 1. A rack gear 221A is provided on an upper surface of the rack portion 221. The rack portion 221 is disposed slightly below the rotating shaft of the motor 30, above the door opening of the railway vehicle 1. Thus, the pinion gear disposed coaxially with the rotating shaft of the motor 30 can be engaged with the rack gear 211A on the upper surface of the rack portion 221. For this reason, the rack portion 221 can be moved in the front-rear direction of the railway vehicle 1, according to the rotation of the motor 30.

The connecting portion 222 connects the door panel 80B and the rack portion 221. The connecting portion 222 is provided so as to extend upward from the upper end portion of the door panel 80B, and the rack portion 221 is connected to an upper end of the connecting portion 222. Thus, the door panel 80B moves in the front-rear direction of the railway vehicle 1, coordinated with a movement of the rack portion 221 according to the rotation of the motor 30, thereby achieving the opening or closing operation of the door 80. In this state, the door panel 80B is guided by a slide rail (or a door rail) to move in the front-rear direction.

Because the rack gear 211A engages the pinion gear coaxial with the motor 30 from above, and the rack gear 221A engages the pinion gear from below, the racks 210 and 220 can be moved in opposite directions according to the rotation of the motor 30. For this reason, the opening operation and the closing operation of the two door panels 80A and 80B can be performed using the single motor 30.

A sloping portion 222A, sloping downward toward the center of the door opening in the front-rear direction of the railway vehicle 1, is provided at the upper end of the connecting portion 222.

The lock pin 230 makes contact with the lock pin contact 223 in the locked state of the door 80. The lock pin contact 223 is provided so as to protrude in a direction opposite to the direction in which the rack portion 221 extends, with respect to the connecting portion 222. The lock pin contact 223 is provided with a lock hole 223A.

The lock hole 223A is a recess provided in an upper surface of the lock pin contact 223. When the door 80 is locked, a lower end of the lock pin 230 (or a pin portion 231 which will described later) is inserted into the lock hole 223A.

The lock pin 230 is provided above the lock pin contact 223 of the rack 220. The lock pin 230 includes a pin portion 231, and a locking device contact 232.

The pin portion 231 is provided so as to extend in the up-down direction.

The locking device contact 232 is attached to an upper end of the pin portion 231, and is provided so as to extend from a connection portion with the pin portion 231 in the horizontal direction, specifically, in a direction opposite to the door opening in the front-rear direction of the railway vehicle 1. The locking device 50 is fixedly disposed below the locking device contact 232, and an upper end of the pin 51 of the locking device 50 and a lower surface of the locking device contact 232 make contact with each other. Thus, when the pin 51 of the locking device 50 protrudes in an upward direction, the locking device contact 232 is lifted in the upward direction. On the other hand, when the pin 51 of the locking device 50 retracts in a downward direction, the locking device contact 232 is lowered in the downward direction due to a weight of the lock pin 230.

As illustrated in FIG. 3 through FIG. 6, in a state where the pin 51 of the locking device 50 protrudes, the lower end of the pin portion 231 connected to the locking device contact 232 is positioned above the sloping portion 222A of the rack 220, and the pin portion 231 does not engage with the lock hole 223A. For this reason, the rack 220 is movable without being affected by the arrangement of the lock pin 230, and the door 80 (the door panels 80A and 80B) is in a state movable in the opening or closing direction.

On the other hand, as illustrated in FIG. 2, in a state where the pin 51 of the locking device 50 is retracted, the lower end of the pin portion 231 is positioned below the sloping portion 222A of the rack 220. In addition, in the fully closed state of the door 80, the pin portion 231 is positioned closer to the lock pin contact 223 than the sloping portion 222A is to the lock pin contact 223 in the front-rear direction of the railway vehicle 1. For this reason, when the pin 51 of the locking device 50 is retracted in in the fully closed state of the door 80, the locking device contact 232 moves downward, and the pin portion 231 engages with the lock hole (or a recessed portion) 223A of the rack 220. Thus, the movement of the rack 220 is restricted, and a rotation of the pinion gear engaging the rack gear of the rack 220 is restricted. As a result, the movement of the rack 210 having the rack gear 211A engaging the pinion gear is restricted. Hence, the movement of the door panels 80A and 80B connected to the racks 210 and 220 is restricted, and the locked state of the door panels 80A and 80B can be achieved.

### First Example of Operation Sequence of Configuration Related to Opening and Closing Operation of Door

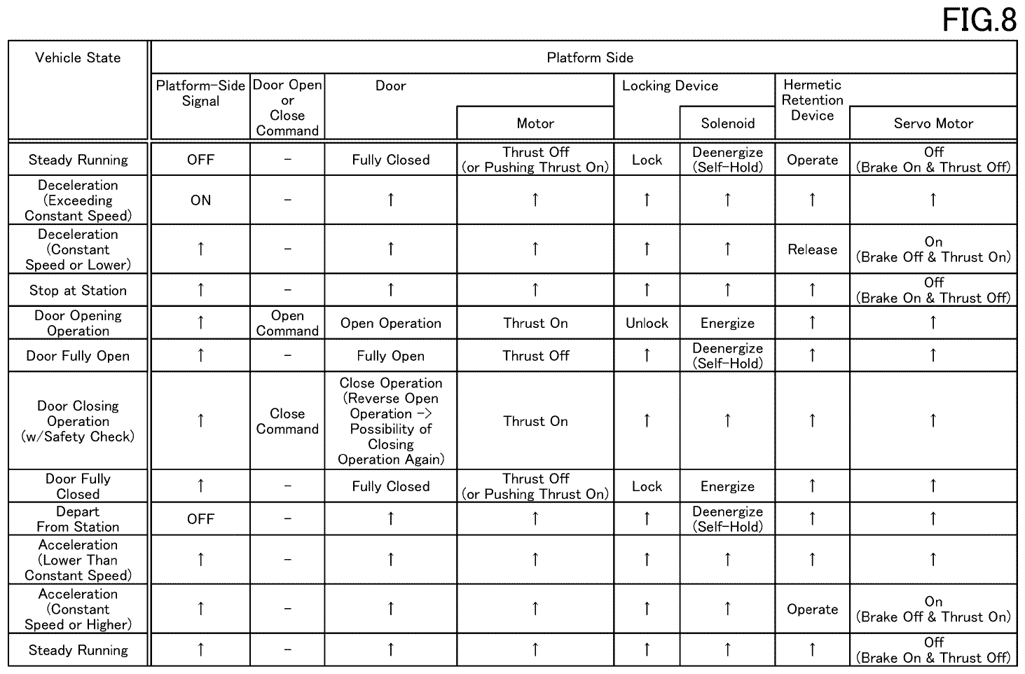

Next, a first example of an operation sequence of a configuration related to the opening or closing operation of the door 80 will be described, with reference to FIG. 8.

FIG. 8 is a diagram illustrating the first example of the operation sequence of the configuration related to the opening or closing operation of the door 80 of the railway vehicle 1. Specifically, FIG. 8 illustrates a specific example of the operation sequence of the door 80, the locking device 50, and the hermetic retention device 55 of the railway vehicle 1 which decelerates from a steady running state and stops at a next stop station, and thereafter departs from the station, until the railway vehicle 1 returns to the steady running state, with respect to the door 80 provided on the side of the railway vehicle 1 on a platform side (that is, adjacent to the platform) of the next stop station.

In this example, it is hereinafter assumed for the sake of convenience that the control related to the opening or closing operation of the door 80 is performed by the regular-use system controller 110.

### <During Steady Running>

During the steady running of the railway vehicle 1, the door 80 is maintained in the fully closed state by a thrust off state of the motor 30. In addition, the door 80 may be maintained in the fully closed state under the control of the regular-use system controller 110, by a state where the motor 30 outputs a predetermined thrust in the direction in which the door panels 80A and 80B press against each other. Moreover, the locking device 50 maintains the locked state of the door 80 due to deenergization (or turning off), by the action of the bidirectional self-holding solenoid. Further, the hermetic retention device 55 maintains the operating state due to deenergization (or turning off), by the action of the deenergizing actuated electromagnetic brake of the servo motor 56.

### <Steady Running to Deceleration to Stopping>

When the railway vehicle 1 starts to decelerate toward the next stop station, the platform-side signal input to the door controller 100 is switched from an “off” state to an “on” state, by the operation performed by the driver or the conductor to turn on the switch 75 or by the output of the signal from the vehicle controller 12.

When the speed of the railway vehicle 1 decelerates to a speed that is a predetermined threshold value Vth1 or lower in an on state of the platform-side signal, the hermetic retention device 55 makes a transition from the operating state to the released state under the control of the regular-use system controller 110. Specifically, when the platform-side signal is in the on state and the speed of the railway vehicle 1 is the threshold value Vth1 or lower, the hermetic retention controller 118 controls the hermetic retention device 55 to make the transition from the operating state to the released state by turning on (or energizing) the servo motor 56 through the hermetic retention drive circuit 119. The threshold value Vth1 may be a value greater than zero, or may be zero. Information related to the speed of the railway vehicle 1 is input from the vehicle controller 12 to the door controller 100 through the transmission device 16. The servo motor 56 can cause the hermetic retention device 55 to make a transition to the released state by releasing the deenergizing actuated electromagnetic brake by energization and moving the support 58 downward from the uppermost end position to the lowermost end position through the motion conversion mechanism 57.

In a case where the door controller 100 cannot detect the released state of the hermetic retention device 55, the door controller 100 may prohibit the opening operation of the door 80 corresponding to the hermetic retention device 55, which will be described later. Moreover, the door controller 100 may notify a stop station or a passenger that the opening operation of the corresponding door 80 is in a prohibited state. The passenger who is riding on the railway vehicle 1 or the passenger who is scheduled to get on the railway vehicle 1 at the stop station can smoothly get on and off the railway vehicle 1 by notifying that the opening operation of the door 80 is in the prohibited state, when compared to a case where no such notification is made.

In the process of stopping the railway vehicle 1 upon arrival at the stop station after the deceleration, the servo motor 56 is turned off (or deenergized) under the control of the door controller 100 after the hermetic retention device 55 makes the transition to the released state. Thus, the servo motor 56 can maintain the released state of the hermetic retention device 55 by the action of the deenergizing actuated electromagnetic brake.

### <Stop to Door Opening Operation>

When the open command is input to the door controller 100 in response to the operation of the opening switch 14A by the driver, the conductor, or the like after the railway vehicle 1 stops, the solenoid of the locking device 50 is turned on (or energized) under the control of the regular-use system controller 110, thereby causing the door 80 to make a transition from the locked state to the unlocked state. Then, under the control of the regular-use system controller 110, the motor 30 outputs the thrust, and the door 80 performs the opening operation.

### <Door Opening Operation to Fully Opened State of Door>

When the door 80 reaches the fully open state, the opening operation ends, and the motor 30 is set to the thrust off state under the control of the regular-use system controller 110, thereby maintaining the fully open state. After the door 80 makes a transition from the locked state to the unlocked state, the locking device 50 is turned off (or deenergized) under the control of the regular-use system controller 110, and the unlocked state of the door 80 caused by turning off (or deenergizing) the locking device 50 is maintained by the action of the bidirectional self-holding solenoid.

During the opening operation of the door 80, various functions related to safety check are performed in parallel, under the control of the regular-use system controller 110. For example, the regular-use system controller 110 monitors whether or not a foreign object is caught between the door 80 and a door pocket (not illustrated) for accommodating the door 80, based on a measured value of the current of the motor 30. The foreign object may be a passenger, an item carried by the passenger, or the like, for example. When it is determined that the foreign object is caught between the door 80 and the door pocket, the door 80 achieves a state where the foreign object can be removed by stopping the opening operation or performing the closing operation by reversing the opening operation, and then performing the opening operation again, for example, under the control of the regular-use system controller 110.

### <Fully Open State to Door Closing Operation>

When the close command is input to the door controller 100 in response to the operation of the closing switch 14B by the driver, the conductor, or the like, the motor 30 outputs the thrust under the control of the regular-use system controller 110, and the door 80 performs the closing operation.

During the closing operation of the door 80, various functions related to the safety check are performed in parallel, under the control of the regular-use system controller 110, similar to the case of the opening operation of the door 80. For example, the regular-use system controller 110 monitors whether or not a foreign object is caught by the door 80 based on the measured value of the current of the motor 30. When it is determined that the foreign object is caught by the door 80, the door 80 achieves the state where the foreign object can be removed by performing the opening operation by reversing the closing operation, and then performing the closing operation again, for example, under the control of the regular-use system controller 110.

### <Door Closing Operation to Fully Closed State of Door>

When the door 80 reaches the fully closed state, the closing operation ends. The locking device 50 causes the door 80 to make a transition from the unlocked state to the locked state by turning on (or energizing) the solenoid under the control of the regular-use system controller 110. The door 80 maintains the fully closed state by the motor 30 that is set to the thrust off state, under the control of the regular-use system controller 110. Further, the door 80 may maintain the fully closed state under the control of the regular-use system controller 110, by a state where the motor 30 outputs a predetermined thrust in the direction in which the door panels 80A and 80B press against each other.

Even in the case where the fully closed state of the door 80 is maintained by turning off the thrust of the motor 30, the thrust of the motor 30 in the closing direction of the door 80 may be continued for a certain period of time even after the door 80 reaches the fully closed state. Specifically, a timing at which the thrust of the motor 30 is turned off may be after the railway vehicle 1 starts. For example, after the railway vehicle 1 reaches a speed that is a predetermined threshold value Vth2 or higher, which will be described later, and the hermetic retention device 55 is switched from the released state to the operating state, the thrust of the motor 30 is turned off under the control of the door controller 100.

### <Departure of Railroad Vehicle>

After the closing operation of the door 80 is completed, the railway vehicle 1 departs from the station after final safety checks are performed by the driver, the conductor, or the like. When the railway vehicle 1 departs from the station, the platform-side signal input to the door controller 100 is switched to the off state by the operation performed by the driver, the conductor, or the like to turn off the switch 75.

The operation to turn off the switch 75 may be performed at another timing.

### <Departure to Acceleration to Steady Running of Railroad Vehicle>

The railway vehicle 1 accelerates toward a steady running state after departing from the station. During the acceleration process of the railway vehicle 1, when the railway vehicle 1 accelerates to a speed that is the predetermined threshold value Vth2 or higher, the hermetic retention device 55 makes a transition from the released state to the operating state, under the control of the regular-use system controller 110. Specifically, when the speed of the railway vehicle 1 becomes the threshold value Vth2 or higher, the hermetic retention controller 118 causes the hermetic retention device 55 to make a transition from the released state to the operating state by turning on the servo motor 56 through the hermetic retention drive circuit 119. The threshold value Vth2 is set to a value greater than zero, for example. The threshold value Vth2 may be greater than the threshold value Vth1 or threshold value Vth3 which will be described below. Accordingly, the regular-use system controller 110 can extend the time for monitoring whether or not a foreign object having a relatively small thickness is caught by the door 80, for example, and reduce a probability of failure to detect the foreign object. The servo motor 56 releases the deenergizing actuated electromagnetic brake by energization, and moves the support 58 upward from the lowermost end position to the uppermost end position through the motion conversion mechanism 57, thereby making it possible to cause the hermetic retention device 55 to make a transition to the operating state.

In a case where the door controller 100 cannot detect the operating state of the hermetic retention device 55, a steady running speed of the railway vehicle 1 may be limited. By limiting the steady running speed, it is possible to reduce a change in atmospheric pressure that occurs when the railway vehicle 1 enters a tunnel, even in a case where an abnormality is generated in the hermetic retention device 55. The limit on the steady running speed may limit the acceleration to a speed that is the threshold value Vth2 or higher, for example. Further, in the case where the door controller 100 cannot detect the operating state of the hermetic retention device 55, the door controller 100 may increase the thrust of the motor 30 in the direction in which the door panels 80A and 80B press against each other. Thus, the door 80 can be prevented from opening during running of the railway vehicle 1. In addition, in the case where the door controller 100 cannot detect the operating state of the hermetic retention device 55, both of the operations described above may be performed.

### Second Example of Operation Sequence of Configuration Related to Opening and Closing Operation of Door

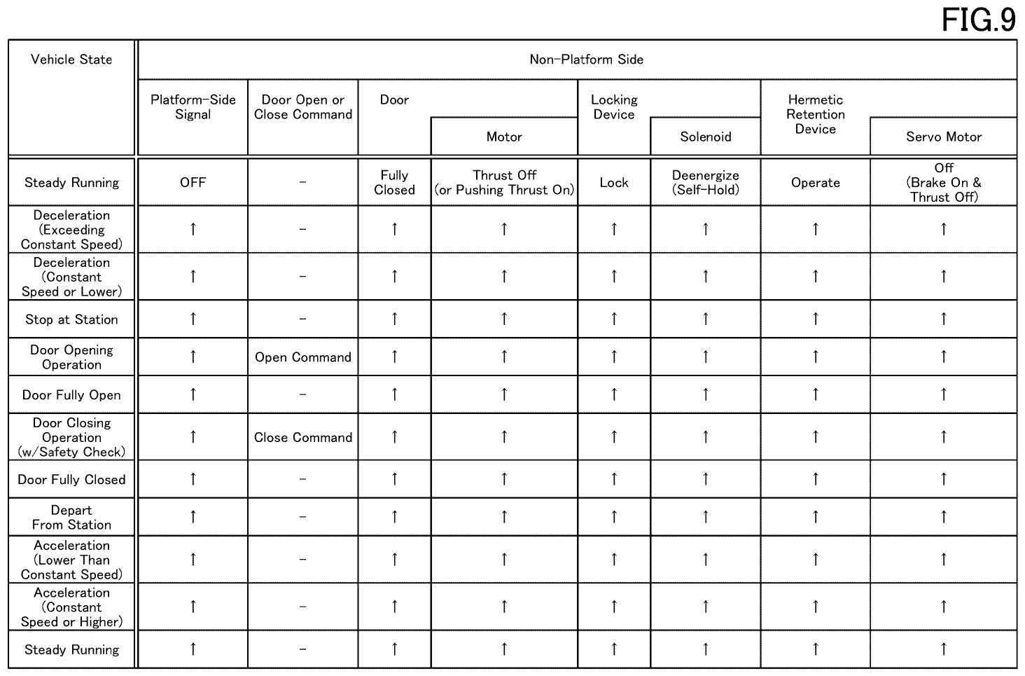

Next, a second example of the operation sequence of the configuration related to the opening or closing operation of the door 80 will be described, with reference to FIG. 9. Specifically, FIG. 9 illustrates a specific example of the operation sequence of the door 80, the locking device 50, and the hermetic retention device 55 of the railway vehicle 1 which decelerates from a steady running state and stops at a next stop station, and thereafter departs from the station, until the railway vehicle 1 returns to the steady running state, with respect to the door 80 provided on the side of the railway vehicle 1 on a non-platform side (that is, non-adjacent to the platform) of the next stop station.

In this example, it is hereinafter assumed for the sake of convenience that the control related to the opening or closing operation of the door 80 is performed by the regular-use system controller 110.

In this example, because the target door 80 is on the non-platform side, the opening or closing operation of the door 80 and the unlocking or locking operation of the locking device 50 are not performed when the railway vehicle 1 stops at the station.

The hermetic retention device 55 is also not caused to make a transition from the operating state to the released state when the railway vehicle 1 stops at the station, and maintains the operating state under the control of the regular-use system controller 110. Specifically, even in a case where the railway vehicle 1 decelerates to a speed that is the threshold value Vth1 or lower, the regular-use system controller 110 maintains the operating state of the hermetic retention device 55 based on the platform-side signal in the “off” state. That is, even in the case where the speed of the railway vehicle 1 becomes the threshold value Vth1 or lower, the regular-use system controller 110 maintains the operating state of the hermetic retention device 55 when the platform-side signal is in the “off” state.

### Third Example of Operation Sequence of Configuration Related to Opening and Closing Operation of Door

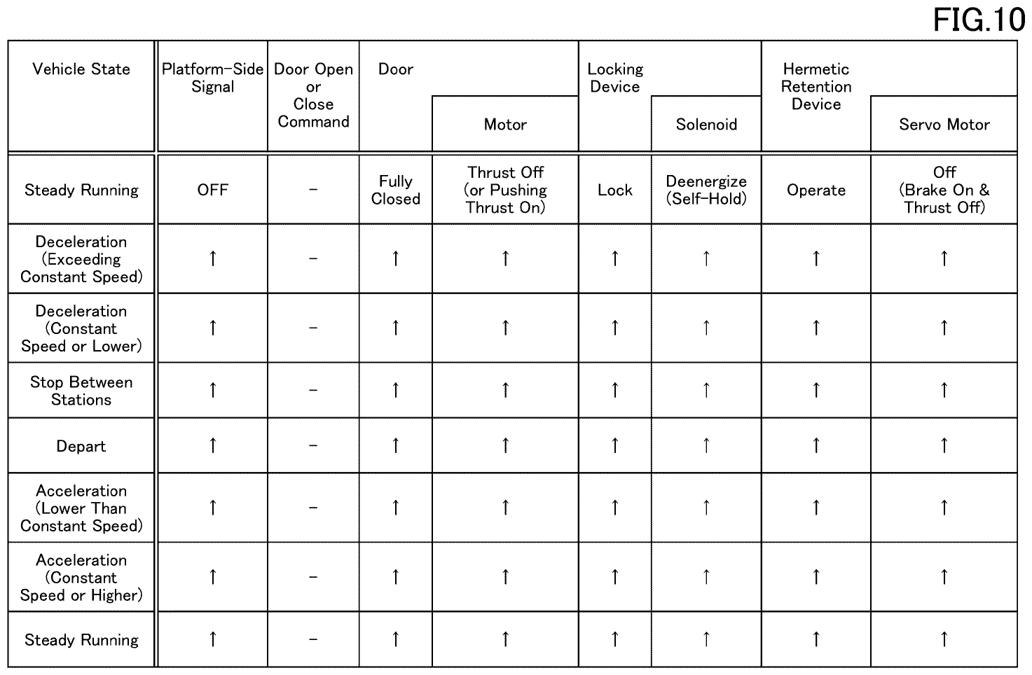

Next, a third example of the operation sequence of the configuration related to the opening or closing operation of the door 80 will be described, with reference to FIG. 10.

FIG. 10 is a diagram illustrating the third example of the operation sequence of the configuration related to the opening or closing operation of the door 80 of the railway vehicle 1. Specifically, FIG. 10 illustrates a specific example of the operation sequence of the door 80, the locking device 50, and the hermetic retention device 55 of the railway vehicle 1 which decelerates from a steady running state and stops between stations, and thereafter departs from the station, until the railway vehicle 1 returns to the steady running state.

In this example, it is hereinafter assumed for the sake of convenience that the control related to the opening or closing operation of the door 80 is performed by the regular-use system controller 110.

In this example, because the stop is between stations, the opening or closing operation of the door 80 and the unlocking or locking operation of the locking device 50 are not performed when the railway vehicle 1 stops.

The hermetic retention device 55 is also not caused to make a transition from the operating state to the released state when the railway vehicle 1 stops between stations, and maintains the operating state under the control of the regular-use system controller 110. Specifically, even in a case where the railway vehicle 1 decelerates to a speed that is the threshold value Vth1 or lower, the regular-use system controller 110 maintains the operating state of the hermetic retention device 55 based on the platform-side signal in the “off” state. That is, even in the case where the speed of the railway vehicle 1 becomes the threshold value Vth1 or lower, the regular-use system controller 110 maintains the operating state of the hermetic retention device 55 when the platform-side signal is in the “off” state.

### Fourth Example of Operation Sequence of Configuration Related to Opening and Closing Operation of Door

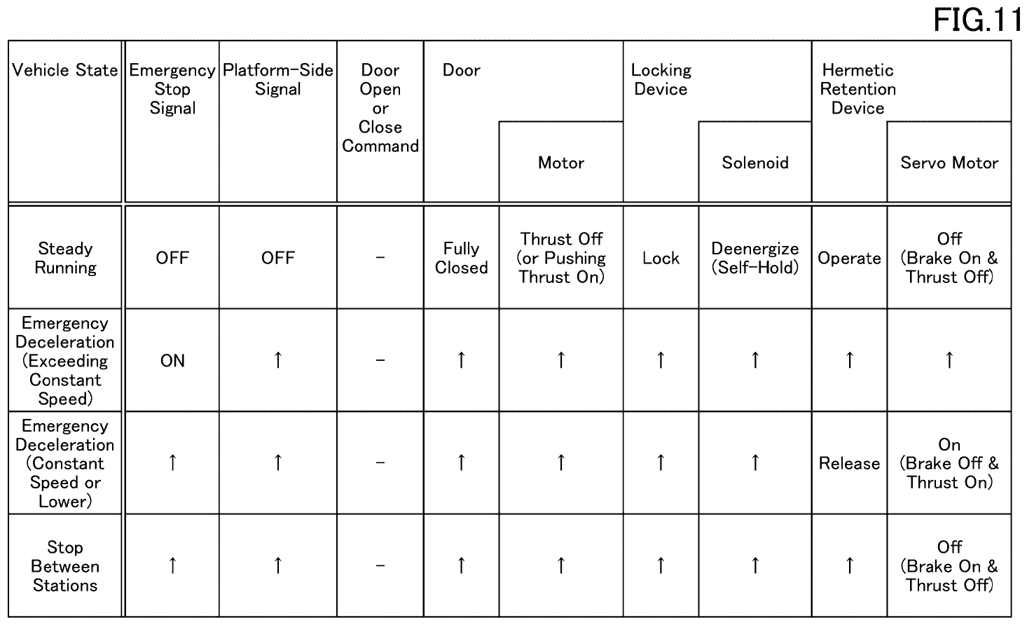

Next, a fourth example of the operation sequence of the configuration related to the opening or closing operation of the door 80 will be described, with reference to FIG. 11.

FIG. 11 is a diagram illustrating the fourth example of the operation sequence of the configuration related to the opening or closing operation of the door 80 of the railway vehicle 1. Specifically, FIG. 11 illustrates a specific example of the operation sequence of the door 80, the locking device 50, and the hermetic retention device 55 of the railway vehicle 1 when the railway vehicle 1 detects an emergency state in response to receiving an emergency stop signal from the outside or the like, and rapidly decelerates from the steady running state to stop between stations.

In this example, it is hereinafter assumed for the sake of convenience that the control related to the opening or closing operation of the door 80 is performed by the regular-use system controller 110.

When the emergency state is detected in response to receiving the emergency stop signal from the outside or the like, the vehicle controller 12 rapidly decelerates the railway vehicle 1 to stop the railway vehicle 1. In addition, the vehicle controller 12 transmits the emergency stop signal to the door controller 100 through the transmission device 16.

When the railway vehicle 1 decelerates to a speed that is the predetermined threshold value Vth3 or lower in a state where the emergency stop signal is in the on state, the hermetic retention device 55 is caused to make a transition from the operating state to the released state, under the control of the regular-use system controller 110. Specifically, in the case where the emergency stop signal is in the on state and the speed of the railway vehicle 1 is the threshold value Vth3 or lower, the hermetic retention controller 118 causes the hermetic retention device 55 to make a transition from the operating state to the released state by turning on the servo motor 56 through the hermetic retention drive circuit 119. The threshold value Vth3 may be a value greater than zero, or may be zero. The threshold value Vth3 may be the same as or different from the threshold value Vth1 described above.

Even when the railway vehicle 1 is suddenly stopped due to the emergency state, the door 80 maintains the fully closed state and the locking device 50 maintains the locked state when the railway vehicle 1 stops. However, in a case where an evacuation outside the railway vehicle 1 is required, the locking device 50 may make a transition to the unlocked state and the door 80 may be opened by the operation performed by the driver or the conductor or a manual operation performed by the passenger. For this reason, the hermetic retention device 55 may be caused to make a transition from the operating state to the released state when the railway vehicle 1 makes the sudden stop due to the emergency state, and thus, it is possible to smoothly perform the evacuation of the passenger to the outside of the railway vehicle 1.

### Fifth Example of Operation Sequence of Configuration Related to Opening and Closing Operation of Door

Next, a fifth example of the operation sequence of the configuration related to the opening or closing operation of the door 80 will be described, with reference to FIG. 11.

In this example, it is hereinafter assumed for the sake of convenience that the control related to the opening or closing operation of the door 80 is performed by the regular-use system controller 110.

Even in a case where the railway vehicle 1 stops at a train stop such as a rail yard or the like, the operation sequence identical to that of the fourth example (FIG. 11) may be adopted. In this case, when the railway vehicle 1 stops, a signal indicating that the railway vehicle 1 stopped at the train stop is input from the vehicle controller 12 to the door controller 100 through the transmission device 16.

When the signal indicating that the railway vehicle 1 is stopped at the train stop is in the on state and the speed of the railway vehicle 1 is a threshold value Vth4 or lower, the hermetic retention controller 118 causes the hermetic retention device 55 to make a transition from the operating state to the released state by turning on the servo motor 56 through the hermetic retention drive circuit 119. The threshold value Vth4 may be a value greater than zero, or may be zero. The threshold value Vth4 may be the same as or different from the threshold values Vth1 and Vth3 described above.

In the case where the railway vehicle 1 stops at the train stop, the door 80 cannot be opened while the hermetic retention device 55 is in the operating state, although the locking device 50 can be manually operated to make a transition from the locked state to the unlocked state and the door 80 can be manually opened and closed because the railway vehicle 1 is stopped. On the other hand, in a case where the hermetic retention device 55 is caused to make a transition from the operating state to the released state when the railway vehicle 1 stops at the train stop, it is possible to smoothly perform the opening or closing operation of the door 80 at the train stop of the railway vehicle 1.

### Further Example of Operation Sequence of Configuration Related to Opening and Closing Operation of Door

Next, a further example of the operation sequence of the configuration related to the opening or closing operation of the door 80 will be described.

The operation sequences of the first to fifth examples described above may be varied or modified, as appropriate.

For example, in the first example described above, the hermetic retention device 55 may be caused to make a transition from the operating state to the released state or from the released state to the operating state when the open command is input to the door controller 100 in response to the operation of the opening switch 14A performed by the driver, the conductor, or the like when the railway vehicle 1 stops at the station. This is because the input of the open command indicates the opening operation of the door 80 in the near future of the door 80 (specifically, immediately after), and no problem will occur if the door controller 100 performs the control related to the opening operation of the door 80 after the hermetic retention device 55 is caused to make a transition from the operating state to the released state in response to the input of the open command. Specifically, in the case where the platform-side signal is in the on state and the open command is input, the regular-use system controller 110 may cause the hermetic retention device 55 to make the transition from the operating state to the released state by turning on the servo motor 56 through the hermetic retention drive circuit 119. In this case, the regular-use system controller 110 advances the operation sequence in the order of the release of the hermetic retention device 55, the unlocking of the locking device 50, and the opening operation of the door 80 in response to the input of the open command. Similarly, the hermetic retention device 55 may be caused to make a transition from the released state to the operating state by a close command input to the door controller 100 in response to the operation of the opening switch 14A performed by the driver, the conductor, or the like when the railway vehicle 1 stops at the station. The input of the close command indicates that the door 80 is not opened in the near future of the door 80, and no problem will occur if the hermetic retention device 55 is caused to make the transition from the released state to the operating state after the door controller 100 completes the control related to the closing operation of the door 80 in response to the input of the close command. Specifically, the regular-use system controller 110 advances the operation sequence in the order of the closing operation of the door 80, the locking of the locking device 50, and the operation of the hermetic retention device 55 in response to the input of the close command. In this state, in a case where the regular-use system controller 110 detects an abnormality in one or both of the locking of the locking device 50 and the hermetic retention device 55, the running of the railway vehicle 1 may be prohibited, or an operation identical to that of the first example described above may be performed.

The transition of the operating state of the hermetic retention device 55 may be performed simultaneously with the unlocking or locking of the locking device 50. In this case, the opening operation of the door 80 is performed after both the airtightness release of the hermetic retention device 55 and the unlocking of the locking device 50 are detected. By simultaneously performing the operations of the hermetic retention device 55 and the locking device 50, it is possible to shorten the time required for the opening or closing operation of the door 80.

In addition, the hermetic retention device 55 may incorporate an emergency battery therein, so as to be able to make a transition from the operating state to the released state by a manual operation, even in a situation where there is no power supply to the railway vehicle 1 from the outside. In this case, in the fourth example and the fifth example described above, the hermetic retention device 55 may maintain the operating state under the control of the regular-use system controller 110 when the railway vehicle 1 stops due to an emergency state or stops at a train stop.

Further, the hermetic retention device 55 may make a transition from the operating state to the released state under the control of the door controller 100 when an emergency door cock of the door 80 is operated. Thus, the door 80 can be manually opened in an emergency.

In addition, the hermetic retention device 55 may make a transition from the operating state to the released state under the control of the door controller 100, in a case where the railway vehicle 1 is in a power failure state. Thus, the door 80 can be manually opened in an emergency.

In the case where the railway vehicle 1 is in the power failure state, the railway vehicle 1 makes a transition to a state where only minimal components are operated by an emergency power supply.

### [Operation]

Next, the operation of the controller and the control method according to the present embodiment will be described.

In the present embodiment, the controller causes the electrically driven hermetic retention device for retaining the airtightness between the door and the opening to be operated or released according to the presence or absence of the possibility of the opening operation of the door of the railway vehicle in the near future. The controller is the door controller 100 described above, for example. The railway vehicle is the railway vehicle 1 described above, for example. The door is the door 80 described above, for example. The hermetic retention device is the hermetic retention device 55 described above, for example.

Moreover, in the control method according to the present embodiment, the controller causes the electrically driven hermetic retention device for retaining the airtightness between the door and the opening to be operated or released according to the presence or absence of the possibility of the opening operation of the door of the railway vehicle in the near future.

Accordingly, the controller can cause the hermetic retention device to make a transition from the operating state to the released state when there is a possibility of an opening operation of the door of the railway vehicle in the near future, for example, and when there is no possibility of the opening operation of the door of the railway vehicle in the near future, the controller can cause the hermetic retention device to make a transition from the released state to the operating state. Accordingly, the controller can suitably control the operation and release of the hermetic retention device according to the open or closed situation of the door of the railway vehicle. In particular, it is possible to positively avoid a mechanical failure of the door, because the door does not open in the operating state of the hermetic retention device.

In the present embodiment, the controller may cause the hermetic retention device to be operated or released according to the speed of the railway vehicle.

Hence, the controller can determine the possibility of the opening operation of the door of the railway vehicle in the near future, according to the speed of the railway vehicle, and can suitably control the operation and release of the hermetic retention device.

In the present embodiment, the controller may cause the hermetic retention device to make a transition from the operating state to the released state when the speed of the railway vehicle becomes relatively lower than a first threshold value. The first threshold value is the threshold values Vth1 described above, for example.

Thus, the controller can suitably cause the hermetic retention device to make a transition from the operating state to the released state in a situation where the railway vehicle decelerates to some extent and there is a possibility of the opening operation of the door of the vehicle at the stop station in the near future.

In the present embodiment, the controller may cause the hermetic retention device to make a transition from the operating state to the released state when the speed of the railway vehicle becomes relatively lower than the first threshold value and the door is on the platform side of the station.

Thus, the controller can suitably cause a transition of only the hermetic retention device corresponding to the door on the platform side from the operating state to the released state in a situation where the railway vehicle decelerates to some extent and there is a possibility of the opening operation of the door of the vehicle at the stop station in the near future.

Moreover, in the present embodiment, the controller may maintain the operating state of the hermetic retention device when the speed of the railway vehicle is relatively lower than the first threshold value and the railway vehicle is located between stations.

Thus, even in a case where the railway vehicle decelerates to some extent, the controller can suitably maintain the operating state of the hermetic retention device in a situation where the railway vehicle is located between stations and there is no possibility of the opening operation of the door in the near future.

In the present embodiment, the controller may cause the hermetic retention device to make a transition from the operating state to the released state when the railway vehicle stops due to an emergency state.

Thus, the controller can suitably cause the hermetic retention device to make a transition from the operating state to the released state in a situation where the railway vehicle is stopped due to an emergency state and there is a possibility of the opening operation of the door in the near future.

In the present embodiment, the controller may cause the hermetic retention device to make a transition from the released state to the operating state when the speed of the railway vehicle becomes relatively higher than a second threshold value. The second threshold value is the threshold value Vth2 described above, for example.

Thus, the controller can suitably cause a transition of the hermetic retention device from the released state to the operating state in a situation where the railway vehicle accelerates to some extent from a stop station and there is no possibility of the opening operation of the door in the near future, for example.

In the present embodiment, the controller may cause the hermetic retention device to make a transition from the released state to the operating state when the speed of the railway vehicle becomes relatively higher than the second threshold value that is larger than the first threshold value.

Thus, the controller can secure a relatively long time from a tie when the door is fully closed until a time when the hermetic retention device makes the transition to the operating state. For this reason, the controller can extend the time for monitoring whether or not a foreign object having a relatively small thickness is caught by the door, for example, and reduce the probability of failure to detect the foreign object.

In the present embodiment, the controller may cause a transition of the hermetic retention device from the operating state to the released state when the railway vehicle is in a power failure state.

Thus, the controller can tolerate the door to be manually opened in an emergency, such as the power failure state of the railway vehicle.

In the present embodiment, the controller may cause the hermetic retention device to make a transition between the operating state and the released state by energizing the hermetic retention device, and may cause the hermetic retention device to maintain the operating state or the released state by deenergizing the hermetic retention device.

Thus, the controller can reduce a power consumption related to the operation and release of the hermetic retention device.

In the present embodiment, the controller may acquire information related to the operating state of the hermetic retention device and perform a diagnosis on an abnormality indication of the hermetic retention device.

Accordingly, the controller can acquire the electrical feature of the hermetic retention device, and diagnose the presence or absence of the abnormality indication of the hermetic retention device, the degree of abnormality indication, or the like, for example. For this reason, the controller can recognize an indication of a failure of the hermetic retention device before the failure actually occurs, and urge the operator or the like to take a measure in advance.

According to the embodiments described above, it is possible to suitably control operation and release of an electrically driven hermetic retention device in the railway vehicle.

Although the configuration examples are numbered with, for example, “first,” or “second,” or the like, the ordinal numbers do not imply priorities of the configuration examples. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A controller configured to perform a process including:
operating or releasing an electrically driven hermetic retention device configured to retain airtightness between a door and an opening of a railway vehicle, according to whether or not there is a possibility of an opening operation of the door within a predetermined period.

2. The controller as claimed in claim 1, wherein the hermetic retention device is operated or released according to a speed of the railway vehicle.

3. The controller as claimed in claim 2, wherein the hermetic retention device is caused to make a transition from an operating state to a released state when the speed of the railway vehicle becomes relatively lower than a first threshold value.

4. The controller as claimed in claim 3, wherein the hermetic retention device is caused to make a transition from the operating state to the released state when the speed of the railway vehicle becomes relatively lower than the first threshold value and the door is located on a platform side of a station.

5. The controller as claimed in claim 3, wherein the hermetic retention device is caused to maintain the operating state when the speed of the railway vehicle is relatively lower than the first threshold value and the railway vehicle is located between stations.

6. The controller as claimed in claim 2, wherein the hermetic retention device is caused to make a transition from the released state to the operating state when the speed of the railway vehicle becomes relatively higher than a second threshold value.

7. The controller as claimed in claim 3, wherein the hermetic retention device is caused to make a transition from the released state to the operating state when the speed of the railway vehicle becomes relatively higher than a second threshold value that is larger than the first threshold value.

8. The controller as claimed in claim 1, wherein the hermetic retention device is caused to make a transition from the operating state to the released state when the railway vehicle stops due to an emergency state.

9. The controller as claimed in claim 1, wherein the hermetic retention device is caused to make a transition from the operating state to the released state when the railway vehicle is in a power failure state.

10. The controller as claimed in claim 1, wherein the hermetic retention device is caused to make a transition between the operating state and the released state by energizing the hermetic retention device, and the hermetic retention device is caused to maintain the operating state or the released state by deenergizing the hermetic retention device.

11. The controller as claimed in claim 1, further comprising:
acquiring information related to an operating state of the hermetic retention device and diagnosing an indication of abnormality of the hermetic retention device.

12. A control method comprising:
operating or releasing, by a controller, an electrically driven hermetic retention device for retaining airtightness between a door and an opening of a railway vehicle according to whether or not there is a possibility of an opening operation of the door within a predetermined period.
